(19) United States
(12) Patent Application Publication
(10) Pub. No.: US 2008/0261617 A1
(43) Pub. Date: Oct. 23, 2008

(54) MOBILE WIRELESS APPARATUS AND CONNECTION METHOD THEREOF

(76) Inventor: Keng-Chung Lin, Kaohsiung City (TW)

Correspondence Address: NORTH AMERICA INTELLECTUAL PROPERTY CORPORATION, P.O. BOX 506, MERRIFIELD, VA, 22116, US

(21) Appl. No.: 11/738,516

(22) Filed: Apr. 22, 2007

(51) Int. Cl. H04Q 7/20

(52) U.S. Cl. 455/456.1

(57) ABSTRACT

A mobile wireless apparatus includes a network interface, a storage and a processing device. The network interface provides a wireless protocol of a personal area network. The storage stores access codes and location indicators. Instead of scanning coverable external apparatuses every time when the mobile wireless apparatus moves from one location to another, the processing device connects to the external apparatuses by reference to the access codes and the location indicators.

### BACKGROUND

The present invention relates to a mobile wireless apparatus and connecting method thereof, and more particularly, relates to a mobile wireless apparatus and connecting method thereof for quickly connecting to a plurality of external apparatuses.

To prevent a user wrestling with an octopus of black and beige cords coming out of the back of their laptop computer, Bluetooth and other personal area network are designed and implemented. To make it convenient, a mobile wireless apparatuses of a personal area network needs to be capable of finding available external apparatuses and then connecting to these external apparatuses disposed in a location where a user stays. Usually, a user will move from one location to another location. When this happens, the mobile wireless apparatus needs to scan available external apparatuses again.

As recited in the Bluetooth specification, i.e. “BLUETOOTH SPECIFICATION Version 2.0+EDR [vol 0]” in 2004, an inquiry scan channel is reserved so that coverable devices listen for inquiry requests on its inquiry scan channel. When receiving inquiry requests, the coverable devices send responses to these requests. In order for a device to discover other devices, it iterates through all possible inquiry scan channel frequencies in a pseudo-random fashion, sending an inquiry request on each frequency and listening for any response.

Inquiry scan channels follow a slower hopping pattern and use an access code to distinguish between occasional occupancy of the same radio frequency by two co-located devices using different physical channels. The access code used on the inquiry channel is taken from a reserved set of inquiry access codes that are shared by all Bluetooth devices. One access code is used for general inquiries, and a number of additional access codes are reserved for limited inquiries. Each device has access to a number of different inquiry scan channels. As all of these channels share an identical hopping pattern, a device may concurrently occupy more than one inquiry scan channel if it is capable of concurrently correlating more than one access code.

A device using one of its inquiry scan channel remains passive until it receives an inquiry message on this channel from another Bluetooth device. This is identified by the appropriate inquiry access code. The inquiry scanning device will then follow the inquiry access code. The inquiry scanning device will then follow the inquiry response procedure to return a response to the inquiring device.

In order for a device to discover other Bluetooth devices, it uses the inquiry scan channel of these devices in order to send inquiry requests. As it has no prior knowledge of the devices to discover, it cannot know the exact characteristics of the inquiry scan channel.

The device takes advantages of the fact that inquiry scan channels have a reduced number of hop frequencies and a slower rate of hopping. The inquiring device transmits inquiry requests on each of the inquiry scan hop frequencies and listens for an inquiry response. This is done at a faster rate, allowing the inquiring device to cover all inquiry scan frequencies in a reasonably short time period.

Inquiring and discoverable devices use a simple exchange of packets to fulfill the inquiring function. The topology during this transaction is a sample and transient point-to-point connection.

With designs like inquiry scan channels as mentioned above, a mobile wireless device is capable of dynamically connecting to a plurality of coverable external devices in a personal area network. The scanning, however, still takes certain time and makes reconnection slow when a user carries a wireless mobile device from one place to another. Since a mobile wireless device in a personal area network emphasizes its mobility, it is important to prevent slow reconnection to coverable devices when a user moves from one location to another, it is not convenient. Based on such analysis, there is a need of a more efficient way for reconnection of a mobile wireless device particularly in a personal area network like Bluetooth.

### SUMMARY OF THE INVENTION

According to a preferred embodiment of the invention, a mobile wireless apparatus that can be carried by a user from one location to another location is disclosed. The mobile wireless apparatus includes a network interface, a storage and a processing device. The network interface uses a wireless protocol of a personal area network covering a certain geographical range, e.g. a Bluetooth network. The storage stores access codes and location indicators of a plurality of external apparatuses disposed at different locations. The processing device connects to the storage and the network interface.

The processing device initializes a connection with a coverable external apparatus with the access code of the coverable external apparatus if the location indicator of the coverable external apparatus indicates that the coverable external apparatus is at the same location where the mobile wireless apparatus locates. In other words, the mobile wireless apparatus does not need to scan for coverable external apparatuses every time when the user brings the mobile wireless moving from one location to another. The connection is faster and makes the use of the mobile wireless apparatus more convenient.

### BRIEF DESCRIPTIONS OF DRAWINGS

FIG. 1 illustrates a mobile wireless apparatus that can be carried around different locations;

FIG. 2 illustrates a diagram providing an example of implementing the mobile wireless apparatus;

FIG. 3 illustrates logic concept of location indicators;

FIG. 4 illustrates a flowchart showing a logic how the mobile wireless apparatus connects to external apparatuses;

FIG. 5 illustrates a more detailed example for implementing the mobile wireless apparatus; and

FIG. 6 illustrates a user interface for a user to manage the location indicators and access codes.

### DETAILED DESCRIPTION

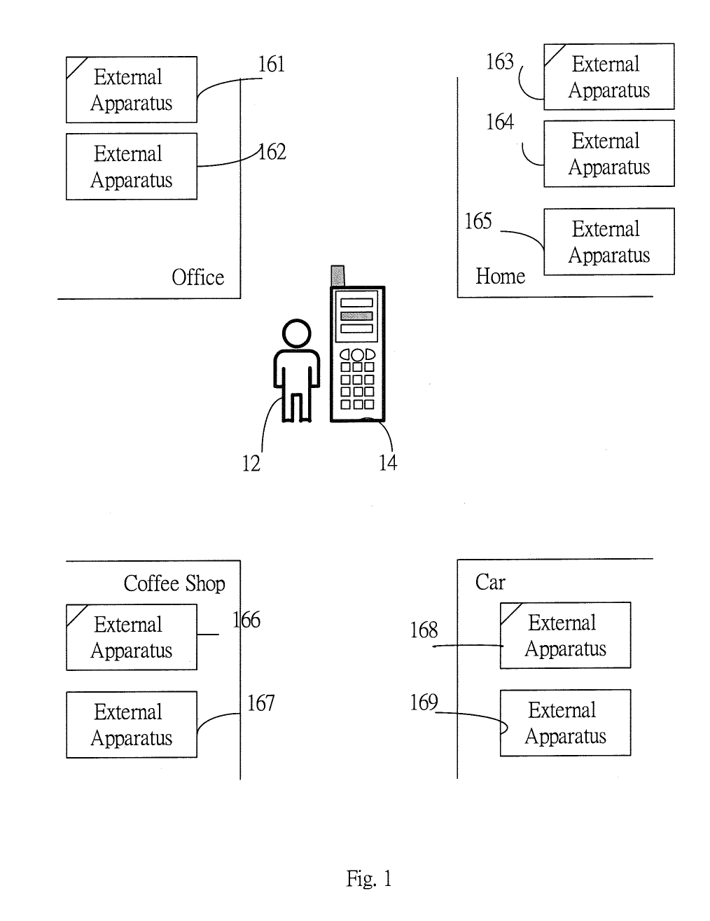

FIG. 1 illustrates a mobile wireless apparatus 12 that can be carried by a user 14 to different locations. For example, the mobile wireless apparatus 12 is a mobile phone and the user 14 brings the mobile phone moving around locations of “Office”, “Home”, “Coffee Shop” and “Car.” In each location, there are several external apparatuses that can be dynamically connected to the mobile wireless apparatus 12 via a wireless protocol over a personal area network, e.g. a Bluetooth network.

For example, in the location of “Office,” the external apparatuses 161 and 162 may be a Bluetooth printer and a Bluetooth PC. In the location of “Home,” the external apparatuses 163, 164 and 165 may be a TV, a speaker and a notebook that support Bluetooth connection. In the “Coffee Shop,” the external apparatuses 166 and 167 may be a jukebox that broadcasting music via Bluetooth interface and a DSL AP server that provides Internet connection via Bluetooth. And in the “Car,” the external apparatuses 168 and 169 may be a speaker and a microphone that support Bluetooth.

When the user 14 moves from one location to another, the mobile wireless apparatus 12 needs to connect to coverable external apparatuses at the same location as the mobile wireless apparatus 12. One way to do so is to perform scanning to find all available external apparatuses every time when the user 14 moves into a location. But it takes long time of scanning and makes it inconvenient for the user 14 to use the mobile wireless apparatus 12.

Instead, according to the preferred embodiment of the invention, the mobile wireless apparatus 12 starts its connection to external apparatuses by reference to access codes and location indicators previously stored in the mobile wireless apparatus 12 when the mobile wireless apparatus 12 moves from one location to another. The following examples illustrate how such function can be implemented.

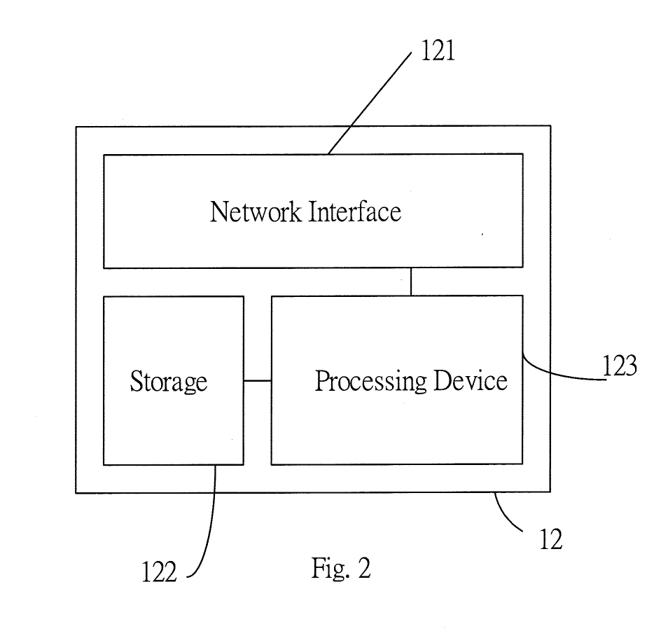

FIG. 2 illustrates an example of implementation of the mobile wireless apparatus 12. The mobile wireless apparatus 12 includes a network interface 121, a storage 122 and a processing device 123. The network interface 121 includes circuits and/or related software that are configured to run a wireless protocol of a personal area network like a Bluetooth network. The storage 122 stores access codes and location indicators of external apparatuses disposed at different locations. The processing device 123, which may also include circuits and software, is coupled to the network interface 121 and the storage 122.

As mentioned above, the access codes and the location indicators are stored in the storage 122 for the mobile wireless apparatus 12 to efficiently connect to corresponding external apparatuses. To find out the access codes and the location indicators for the first time, an initialization, via the traditional scanning, can be performed. For example, when the mobile wireless apparatus 12 is first used in a location, a scanning is performed for searching available external apparatuses in each location. In a Bluetooth network, this can be performed using inquiry scanning channels to find available external apparatuses. When one or more than one external apparatuses are found at a location, access codes of these external apparatuses are stored and these external apparatuses are classified in a set via tagging or location indicators of other data structures.

The “location indicators” may refer to any data structures that are capable of carrying location information of found external apparatuses. For example, each external apparatus may have an associated entry, i.e. a device identification number, a password and a tag that indicates location information, in the storage. These entries can be stored in an array, a file or a database. The tag, which may have a text value of “Office” or a pointer for pointing to a set that contain several external apparatuses found in the same location. In such case, the tags are the location indicators. Because there are many ways known by persons skilled in the art for storing information in various data structure, the invention should not be limited to certain data structure, e.g. the tag as an example described here.

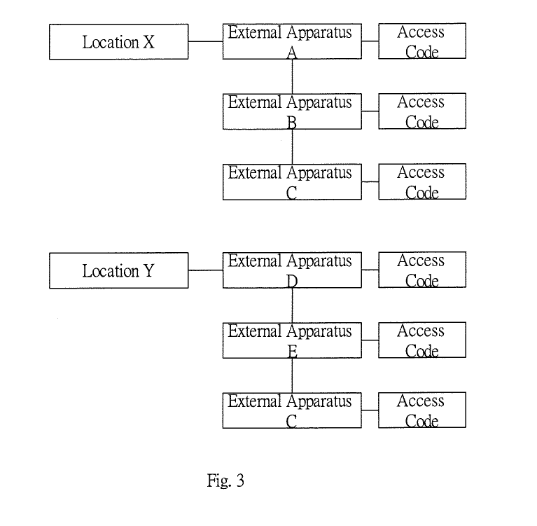

FIG. 3 illustrates an example for recording location indicators. In “Location X”, there are three external apparatuses “A”, “B” and “C.” In “Location Y”, there are three external apparatuses “D”, “E” and “C.” This logical structure can be stored into various physical data structures. From the information carried by the location indicators, each external apparatus can be identified which group the external apparatus belongs to. Please note that an external apparatus can be classified in more than one location, e.g. the external apparatus “C.” An example in the real world is that the external apparatus “C” is a Bluetooth earphone and usually moves with a mobile phone, i.e. the mobile wireless apparatus.

With the information carried by the location indicators, the network interface 121 and the processing device 123 now do not need to scan every coverable external apparatus. Particularly, most external apparatuses usually do not move from a location to another location. When one external apparatus is found, it is very possible that other external apparatuses once locates at the same location of the found external apparatus are also available at the same location.

Under such finding, one or more external apparatuses for each location can be chosen as a representative external apparatus in advance or dynamically so as to guess where the mobile wireless apparatus 12 locates. In the example illustrated in FIG. 3, there are two locations ever being recorded, i.e. “Location X” and “Location Y.” If the external apparatus A, and the external apparatus D are chosen as representative apparatuses for “Location X” and “Location Y” respectively, the processing device 123 now only needs to test whether any of the representative external apparatuses exists by trying to connect to the representative external apparatuses using the access codes, e.g. identification codes and passwords.

For example, if the external apparatus A is successfully connected, the processing device 123 next tries to connect to the external apparatus B and the external apparatus C using the access codes previously stored in the storage 122, e.g. a RAM or a Flash or a hard disk or any other memory devices. This is much faster than scanning all coverable external apparatuses, which slow speed usually makes a user fell inconvenient.

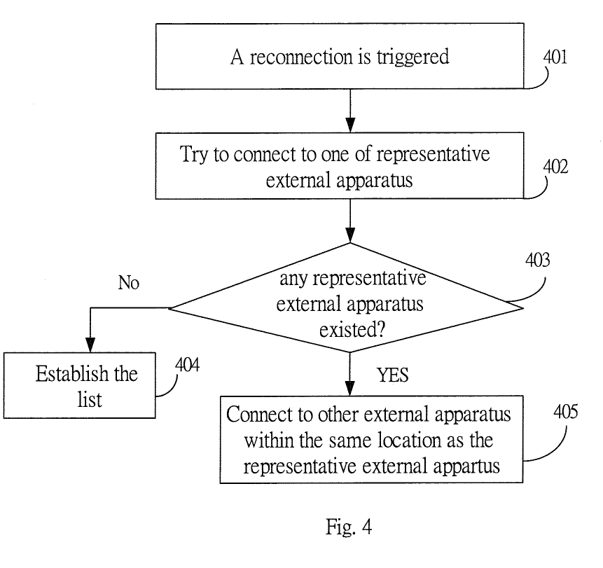

FIG. 4 illustrates a flowchart for explaining this concept. When a user moves from “Location X” to “Location Y” in FIG. 3, the processing device 123 detects that the external apparatuses A and B are now disconnected. When such condition happens or the user manually operates the mobile wireless apparatus 12 to “move” to another location, a reconnection is triggered (step 401). The processing device 123 then tries to connect to the representative apparatuses, e.g. the external apparatus A and the external apparatus D (step 402, step 403). If no representative apparatus is found, the mobile wireless apparatus 12 may show a display, providing information to the user that no representative external apparatus is found, a scanning may be necessary for establishing a new list including location indicators and access codes (step 404). Otherwise, the mobile wireless apparatus 12 tries to connect to other external apparatuses of the same location as the representative external apparatus found (step 405).

The logic illustrated in FIG. 4 can be implemented into corresponding software running on a open platform or a close platform. For example, the program can be implemented as an application of smart Bluetooth connecting software that runs on Microsoft Windows CE™, or Symbian™. Alternatively, the logic of FIG. 4 can be implemented in a close platform like a mobile phone system, a handheld game console. The representative external apparatuses can be chosen in advance or dynamically chosen randomly. The number of representative external apparatuses can be one or more than one. In addition, some external apparatuses may not be chosen to be a representative external apparatuses if they are designed to move with the mobile wireless apparatus 12. For example, a Bluetooth earphone that usually appears in each location list will not be chosen as the representative external apparatus. Printers or apparatuses that are difficult to be moved, in contrast, are assigned higher priority when choosing representative apparatuses.

Alternatively, the processing device 123 may provide an display for the user to choose where he is moving into. In the example of FIG. 3, the user may choose location X, location Y or a new location. When the location X or location Y is chosen, the processing device 123 tries to connect to external apparatuses by reference to their location indicators. If the new location option is chosen, the processing device 123 starts scanning to stored a new set of access codes and location indicators of found external apparatuses at that location.

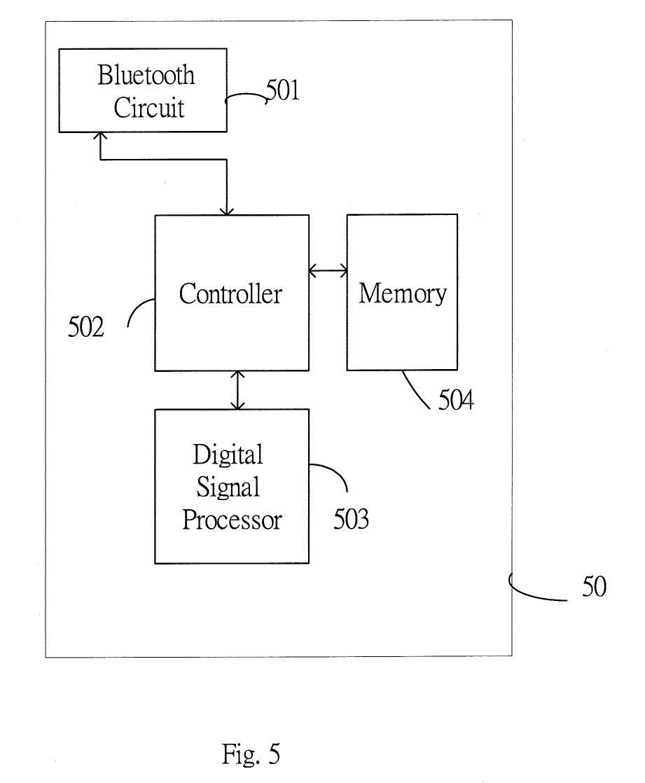

FIG. 5 illustrates a diagram of an integrated circuit chip 50 that has the feature as mentioned above. The chip 50 has a Bluetooth circuit 501, a controller 502, a digital signal processor 503 and a memory 504. The memory 504 stores programs as recited in FIG. 4. In addition, the memory 504 stores access codes and location indicators as mentioned above. The controller, e.g. an ARM core, accesses the memory for retrieving and running the programs. When the controller 502 finds necessary to reconnect to another set of external apparatuses, the controller 502 tries to connect to representative external apparatuses to determine whether the user moves into a location where access codes and location indicators of external apparatuses locate are saved before. If this is true, a faster connection is performed.

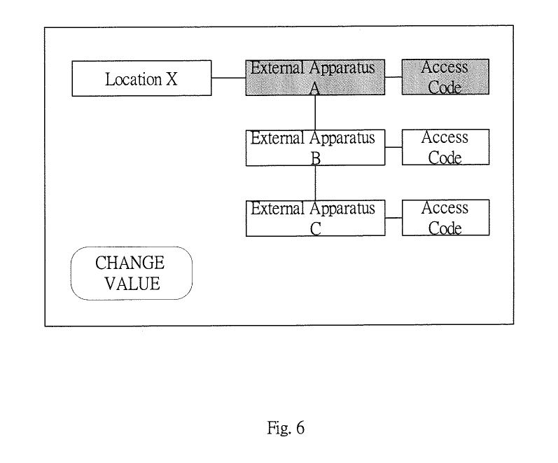

FIG. 6 illustrates a user interface provided to a user so that the user can manage access codes and location indicators. For example, the user interface allows a user to add or remove or update access codes and/or location indicators. Moreover, the user may set certain filter for filtering some external apparatuses or create a new category not completely the same as the scanning results. For example, a user may set a filter for filtering all printers or earphones for more conveniently use the mobile wireless apparatus 12.

While the invention has been described in conjunction with several specific embodiments, it is evident to those skilled in the art that many further alternatives, modifications and variations will be apparent in light of the foregoing description. Moreover, it is contemplated that the present invention is not limited to the nominal 1 gigabit per second data transmission rate and above-described protocols, and may be implemented with other appropriate data transmission rates and protocols. Thus, the invention described herein is intended to embrace all such alternatives, modifications, applications and variations as may fall within the spirit and scope of the appended claims.

What I claimed is:

1. A mobile wireless apparatus that is capable of being carried by a user from one location to another location, comprising:
a network interface using a wireless protocol of a personal area network covering a certain geographical range;
a storage for storing access codes and location indicators of a plurality of external apparatuses disposed at a plurality of locations; and
a processing device coupled to the storage and the network interface, wherein the processing device initializes a connection with a coverable external apparatus with the access code of the coverable external apparatus if the location indicator of the coverable external apparatus indicates that the coverable external apparatus is at the same location where the mobile wireless apparatus locates.

2. The mobile wireless apparatus of claim 1, wherein the location indicators are configured so that there is a representative external apparatus chosen in each location and the processing device tries to connect to the representative apparatuses of different locations to determine where the mobile wireless apparatus locates.

3. The mobile wireless apparatus of claim 2, wherein the processing device further connects to other external apparatuses in the same location as that of the representative external apparatus that is found at the same location as the mobile wireless apparatus.

4. The mobile wireless apparatus of claim 1, wherein the access code includes an identification number and a password.

5. The mobile wireless apparatus of claim 1, wherein the plurality of external apparatuses are categorized by location with the location indicators.

6. The mobile wireless apparatus of claim 5, further comprising:
an operating interface for the user to select one category wherein in response to the selection, the processing device initializes connection with at least one external apparatus by reference to the location indicators.

7. The mobile wireless apparatus of claim 1, further comprising:
a user interface for the user to manage the location indicators and the access codes.

8. The mobile wireless apparatus of claim 7, wherein the user interface provides the user to set at least one filter so that under filter settings of the user interface, only a portion of the external apparatuses in the location where the mobile wireless apparatus are connected.

9. The mobile wireless apparatus of claim 1, wherein the wireless protocol is Bluetooth.

10. The mobile wireless apparatus of claim 1, wherein the processing device detects and adds information of the location indicator and the access code of a newly found external apparatuses where the mobile wireless apparatus locates.

11. The mobile wireless apparatus of claim 1, wherein the processing device updates the location indicators and the access codes to be consistent with corresponding external apparatuses locates where the mobile wireless apparatus locates.

12. A method for connecting a mobile wireless apparatus to external apparatuses covered in a personal area network, comprising:
maintaining location indicators of the external apparatuses located in different locations;
storing access codes of the external apparatuses located in different locations; and
connecting to the external apparatuses covered in the personal area network where the mobile wireless apparatus locates according to the location indicators instead of scanning the external apparatuses.

13. The method of claim 12, wherein the personal area network is under Bluetooth protocol.

14. The method of claim 12, further comprising:
choosing a representative external apparatus for each location; and
trying to connect to the representative external apparatuses to determine where the mobile wireless apparatus locates.

15. The method of claim 14, further comprising:
connecting to other external apparatuses in the same location as that of the representative external apparatus that is at the same location as the mobile wireless apparatus by reference to the location indicators.
